(19) United States
(12) Patent Application Publication
(10) Pub. No.: US 2016/0255428 A1
(43) Pub. Date: Sep. 1, 2016

(54) METHOD AND SYSTEMS FOR LOGICAL TOPOLOGY OPTIMIZATION OF FREE SPACE OPTICAL NETWORKS

(71) Applicant: BOARD OF TRUSTEES OF THE UNIVERSITY OF ARKANSAS, Little Rock, AR (US)

(72) Inventors: Rabindra Ghimire, Richardson, TX (US); Seshadri Mohan, Little Rock, AR (US)

(21) Appl. No.: 14/632,830

(22) Filed: Feb. 26, 2015

(51) Int. Cl. H04Q 11/00; H04B 10/11

(52) U.S. Cl. CPC H04Q 11/0062; H04B 10/11; H04Q 2011/0098; H04Q 2011/0086

(57) ABSTRACT

The present disclosure relates to presenting a transceiver system for automatic tracking and dynamic routing for free space optical (FSO) communication to reduce the blocking probability and increase the percentage recovery of failed traffic. In one embodiment, for a FSO network including multiple transmitters and receivers, a logical topology is crustucted. Then the logical topology is optimized by calculating the traffic of each the lightpaths in the logical topology with a mesh architecture using a traffic matrix, such as using a mixed integer linear programming (MILP) formulation, to minimize a maximum traffic flow of the lightpaths interconnecting the nodes of the logical topology. Based on the optimized logical topology, routing is calculated to obtain a plurality of transmitter/receiver assignments for the transmitters and the receivers. Then the routing of the transmitters and the receivers may be controlled based on the corresponding transmitter/receiver assignments.

### FIELD OF THE DISCLOSURE

The present disclosure relates generally to free space optical (FSO) network architectures, and more particularly to a transceiver system for automatic tracking and dynamic routing for FSO communication with dynamic optimization and dynamic reconfiguration of logical topology, methods of using the same, and application of the same.

### BACKGROUND OF THE DISCLOSURE

The background description provided herein is for the purpose of generally presenting the context of the present disclosure. The subject matter discussed in the background of the disclosure section should not be assumed to be prior art merely as a result of its mention in the background of the disclosure section. Similarly, a problem mentioned in the background of the disclosure section or associated with the subject matter of the background of the disclosure section should not be assumed to have been previously recognized in the prior art. The subject matter in the background of the disclosure section merely represents different approaches, which in and of themselves may also be disclosures. Work of the presently named inventors, to the extent it is described in the background of the disclosure section, as well as aspects of the description that may not otherwise qualify as prior art at the time of filing, are neither expressly nor impliedly admitted as prior art against the present disclosure.

With the tremendous growth in bandwidth intensive dynamic real time traffic, the network architecture is shifting toward the model that consists of high speed routers and optical fibers. Due to unregulated bandwidth, free space optical (FSO) becomes an attractive alternative network architecture model that provides low cost, low power solutions with high security and data rates [1], in order to meet the requirement of high capital cost for the fiber to the home service and the strict RF regulations for providing metro network extensions, and last mile or enterprise connectivity.

Generally, the FSO transceivers remain in static locations to avoid any misalignments and to maintain line of sight [2, 3, 7, 22, 23]. The point to point FSO link provides higher data rates but in a wireless environment the channel is highly dynamic, and the system may experience considerable degradation in performance, which will increase blocking probability and reduce survivability. With the increasing demand for multimedia applications, it is necessary for any network to provide the ability to dynamically optimize the network under changing traffic and failure patterns.

Most of the literatures [4, 5, 6] have studied logically rearrangeable multihop lightwave networks, which consist of a distributed topology with a small number of specific wavelengths assigned to users in a manner that allows any pair of users to communicate either directly or via one or more intermediate users, both with uniform traffic [6] and that with non-uniform traffic [8].

Reconfiguration refers to changing the existing logical topology to a new logical topology by changing the orientation of one or more links in the physical topology [5, 9]. With the capability to rearrange, it is possible to design networks that are traffic-adaptive and self-healing, but the problem is that the reconfiguration might interrupt the existing traffic so as to degrade the performance of the network. Reference [10] studies the optimization problem to obtain the logical topology that aims to minimize the maximum flow in a link for a given traffic. To tackle dynamically changing traffic pattern, reference [11] develops an algorithm that tries to minimize the number of branch exchanges required to change the logical topology. While reference [12] presents near optimal policies for reconfiguring a network, reference [13] studies the frequency of reconfiguration and retuning strategy for optical transceivers. In [14], the performance impact of partial reconfiguration on multihop lightwave networks is studied and bounds on performance are derived. By limiting reconfigurability to be partial, the tunability range of transceivers is restricted, which limits the ability to adapt to dynamically changing traffic.

The problem of designing optimal logical topology for fiber optic communications has also been addressed. Reference [15] formulates the logical topology design problem as a nonlinear optimization problem with the objective to minimize the maximum offered load or delay. In reference [15], the authors divide the problem into several sub-problems and use simulated annealing to solve each one separately. Reference [16] develops linear formulation for the logical topology design problem with the objective to minimize the average hop length. But the authors assume the presence of wavelength converters at every node. A mixed integer linear programming (MILP) formulation to design the optimal logical topology without wavelength converters that is suitable for fiber optic communications has also been developed [17].

Therefore, a heretofore unaddressed need exists in the art to address the aforementioned deficiencies and inadequacies.

### SUMMARY OF THE DISCLOSURE

In one aspect of the present disclosure, a method for automatic tracking and dynamic routing for free space optical (FSO) communication is provided. In certain embodiments, the method includes: (a) constructing a logical topology of a FSO network comprising a plurality of transmitters and a plurality of receivers, each of the transmitters and each of the receivers being assigned with a wavelength to form a plurality of physical links between the transmitters and the receivers, where each of the physical links is formed between one of the transmitters and one of the receivers being assigned with the same wavelength, where the logical topology includes: (i) a plurality of nodes, each representing at least one of the transmitters and at least one of the receivers; and (ii) a plurality of logical links interconnecting the plurality of nodes, wherein each of the logical links represents a lightpath having a traffic thereon and comprises one or more of the physical links; (b) optimizing the logical topology by calculating the traffic of each the lightpaths in the logical topology with a mesh architecture using a traffic matrix to minimize a maximum traffic flow of the lightpaths; (c) calculating routing of the optimized logical topology to obtain a plurality of transmitter/receiver assignments for the transmitters and the receivers; and (d) controlling routings of the transmitters and the receivers based on the corresponding transmitter/receiver assignments.

In certain embodiments, the FSO network comprises M of the transmitters and M of the receivers in an M×M configuration, wherein M is a positive integer.

In certain embodiments, each of the nodes is configured to communicate with at least one of the other of the nodes via at least one of the lightpaths.

In certain embodiments, for each of the logical links, the nodes being interconnected by the logical link comprises a source node and a destination node.

In certain embodiments, for each of the nodes, a number of the lightpaths originating from the node is no greater than a number of transmitters being represented by the node, and a number of the lightpaths terminating at the node is no greater than a number of receivers being represented by the node.

In certain embodiments, for each of the logical links, the nodes being interconnected by the logical link further comprise one or more intermediate nodes.

In certain embodiments, the optimizing the logical topology is performed using a mixed integer linear programming (MILP) formulation. In certain embodiments, the optimizing the logical topology is performed using the MILP formulation by:
applying degree constraints to the logical topology to constrain the logical topology to a predetermined logical degree;
applying wavelength continuity constraints to each of the lightpaths of the logical topology, such that for each of the lightpaths, only the transmitters and the receivers being assigned with a same wavelength are used at each the nodes being interconnected by the logical link representing the lightpath;
applying wavelength continuity constraints to the logical topology, such that for each of the nodes, each of the transmitters or each of the receivers being assigned with the wavelength is used by only one of the lightpaths;
applying conservation of wavelength constraints to the logical topology, such that for each of the lightpaths, at least one of the transmitters and at least one of the receivers being assigned with the same wavelength are reserved for the lightpath at each the nodes being interconnected by the logical link representing the lightpath;
applying traffic routing constraints to each of the lightpaths of the logical topology, such that for each of the lightpaths, the traffic on the lightpath is no more than the maximum traffic flow of the logical topology;
applying flow conservation constraints to each of the nodes of the logical topology, such that for each of the nodes, the traffic flowing into the node balances the traffic flowing out of the node; and
applying hop-bound constraints to the logical topology such that for each of the lightpaths, a summation of a number of hops along the lightpath is no greater than a hop bound of the lightpath.

In certain embodiments, the calculating routing of the optimized logical topology is performed by generalized multi-protocol label switching (GMPLS) using a routing protocol and a signaling protocol. In certain embodiments, the routing protocol is open shortest path first with traffic engineering (OSPF-TE), and the signaling protocol is resource reservation protocol with traffic engineering (RSVP-TE).

In certain embodiments, the method further includes: in response to detecting a failure at a node or a physical link of the FSO network, re-performing steps (b)-(d) to re-optimize the logical topology of the FSO network with the failure.

Another aspect of the present disclosure relates to a transceiver system for automatic tracking and dynamic routing for free space optical (FSO) communication, which includes: (a) at least one FSO network, each comprising a plurality of transmitters and a plurality of receivers, each of the transmitters and each of the receivers being assigned with a wavelength to form a plurality of physical links between the transmitters and the receivers, wherein each of the physical links is formed between one of the transmitters and one of the receivers being assigned with the same wavelength; and (b) a computer having a processor and a storage device storing computer executable codes, wherein the computer executable code, when executed at the processor, is configured to perform the method as stated above.

In certain embodiments, the FSO network comprises M of the transmitters and M of the receivers in an M×M configuration, wherein M is a positive integer.

In certain embodiments, each of the nodes is configured to communicate with at least one of the other of the nodes via at least one of the lightpaths.

In certain embodiments, for each of the logical links, the nodes being interconnected by the logical link comprises a source node and a destination node.

In certain embodiments, for each of the nodes, a number of the lightpaths originating from the node is no greater than a number of transmitters being represented by the node, and a number of the lightpaths terminating at the node is no greater than a number of receivers being represented by the node.

In certain embodiments, for each of the logical links, the nodes being interconnected by the logical link further comprise one or more intermediate nodes.

In certain embodiments, the computer executable code, when executed at the processor, is configured to perform optimizing the logical topology using a mixed integer linear programming (MILP) formulation. In certain embodiments, the computer executable code, when executed at the processor, is configured to perform optimizing the logical topology using the MILP formulation by:
applying degree constraints to the logical topology to constrain the logical topology to a predetermined logical degree;
applying wavelength continuity constraints to each of the lightpaths of the logical topology, such that for each of the lightpaths, only the transmitters and the receivers being assigned with a same wavelength are used at each the nodes being interconnected by the logical link representing the lightpath;
applying wavelength continuity constraints to the logical topology, such that for each of the nodes, each of the transmitters or each of the receivers being assigned with the wavelength is used by only one of the lightpaths;
applying conservation of wavelength constraints to the logical topology, such that for each of the lightpaths, at least one of the transmitters and at least one of the receivers being assigned with the same wavelength are reserved for the lightpath at each the nodes being interconnected by the logical link representing the lightpath;
applying traffic routing constraints to each of the lightpaths of the logical topology, such that for each of the lightpaths, the traffic on the lightpath is no more than the maximum traffic flow of the logical topology;
applying flow conservation constraints to each of the nodes of the logical topology, such that for each of the nodes, the traffic flowing into the node balances the traffic flowing out of the node; and
applying hop-bound constraints to the logical topology such that for each of the lightpaths, a summation of a number of hops along the lightpath is no greater than a hop bound of the lightpath.

In certain embodiments, the computer executable code, when executed at the processor, is configured to perform calculating routing of the optimized logical topology by generalized multi-protocol label switching (GMPLS) using a routing protocol and a signaling protocol. In certain embodiments, the routing protocol is open shortest path first with traffic engineering (OSPF-TE), and the signaling protocol is resource reservation protocol with traffic engineering (RSVP-TE).

In certain embodiments, the computer executable code, when executed at the processor, is further configured to perform: in response to detecting a failure at a node or a physical link of the FSO network, re-performing steps (b)-(d) to re-optimize the logical topology of the FSO network with the failure.

A further aspect of the present disclosure relates to a non-transitory computer readable medium storing computer executable code, wherein the computer executable code, when executed at a processor, is configured to implement the method as described above.

These and other aspects of the present disclosure will become apparent from the following description of the preferred embodiments taken in conjunction with the following drawings, although variations and modifications thereof may be affected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment.

FIG. 1 shows a method for automatic tracking and dynamic routing for free space optical (FSO) communication according to one embodiment of the present disclosure.

FIG. 2 shows a transceiver system for automatic tracking and dynamic routing for FSO communication according to one embodiment of the present disclosure.

FIG. 3A schematically shows the architecture of tracking FSO according to one embodiment of the present disclosure, where a central node may track and switch the traffic to other nodes at a distance of D meters that are in line of sight with it.

FIG. 3B schematically shows the architecture of tracking FSO according to one embodiment of the present disclosure, where a central node may track and switch the traffic to any other nodes at D or √2D meters from it and are in line of sight of it.

FIG. 3C schematically shows the architecture of tracking according to one embodiment of the present disclosure, where a central node may track and switch traffic directly to other nodes that are at D, √2D or 2D meters away from it and are in line of sight with it.

FIG. 4A schematically shows an example of the 6-node network utilized in the MILP formulation simulation using CPLEX according to one embodiment of the present disclosure.

FIG. 4B schematically shows an optimal logical topology for 6-node network from CPLEX according to FIG. 3A for a sample uniform traffic matrix according to one embodiment of the present disclosure.

FIG. 4C schematically shows an optimal logical topology for 6-node network from CPLEX according to FIG. 3B for a sample uniform traffic matrix according to one embodiment of the present disclosure.

FIG. 4D schematically shows an optimal logical topology for 6-node network from CPLEX according to FIG. 3C for a sample uniform traffic matrix according to one embodiment of the present disclosure.

FIG. 5 shows blocking performance for the three embodiments for the sample uniform traffic matrix as shown in FIGS. 3A-3C according to certain embodiments of the present disclosure.

FIG. 6A shows the optimal logical topology according to FIG. 3A for the case after one of the transmitting lasers at node 1 fails according to one embodiment of the present disclosure.

FIG. 6B shows comparisons of the blocking performance of the optimal logical topology according to FIG. 3A according to certain embodiments of the present disclosure, including (a) normal conditions without failure, (b) a single failure of a transmitter or receiver at a node and (c) the new optimized logical topology after the failure of a transmitter or receiver.

FIG. 7A shows the optimal logical topology according to FIG. 3B after one of the lasers in node 1 fails according to one embodiment of the present disclosure.

FIG. 7B shows comparisons of the blocking performance of the optimal logical topology according to FIG. 3B according to certain embodiments of the present disclosure, including (a) normal conditions without failure, (b) a single failure of a transmitter or receiver at a node and (c) the new optimized logical topology after the failure.

FIG. 8A shows the optimal logical topology according to FIG. 3C after one of the lasers in node 2 fails according to one embodiment of the present disclosure.

FIG. 8B shows comparisons of the blocking performance of the optimal logical topology according to FIG. 3C according to certain embodiments of the present disclosure, including (a) normal conditions without failure, (b) a single failure of a transmitter or receiver at a node and (c) the new optimized logical topology after the failure.

FIG. 9 shows the mean recovery ratio for the three embodiments as shown in FIGS. 3A-3C after the transmitter failure according to certain embodiments of the present disclosure.

FIG. 10 shows comparison of the simulation results with respect to recovered traffic for three different embodiments as shown in FIGS. 3A-3C with link failure according to certain embodiments of the present disclosure.

FIG. 11A shows the logical topology according to FIG. 3A for a sample non-uniform traffic matrix according to one embodiment of the present disclosure.

FIG. 11B shows the logical topology according FIG. 3A for a sample non-uniform traffic matrix with restriction maximum of one lightpath per source destination pair according to one embodiment of the present disclosure.

FIG. 11C shows the logical topology according to FIG. 3A for a sample non-uniform traffic matrix using all transmitter and receiver according to one embodiment of the present disclosure.

FIG. 12 shows blocking performances with Q possible lightpaths between node pairs, restricting maximum of one lightpath per node pairs (Q=1) and using all the available transmitter and receiver in each nodes according to FIG. 3A for a sample non-uniform traffic matrix according to certain embodiments of the present disclosure.

### DETAILED DESCRIPTION OF THE DISCLOSURE

The disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The description is now made as to the embodiments of the present disclosure in conjunction with the accompanying drawings. Although various exemplary embodiments of the present disclosure disclosed herein may be described in the context of free space optical (FSO) network architectures, it should be appreciated that aspects of the present disclosure disclosed herein are not limited to being used in connection with one particular transceiver system for automatic tracking and dynamic routing for free space optical (FSO) communication with dynamic optimization and dynamic reconfiguration of logical topology and may be practiced in connection with other types of transceiver systems with dynamic optimization and reconfiguration without departing from the scope of the present disclosure disclosed herein.

The present disclosure relates to a tracking transceiver for FSO, which can be used to solve the last mile access, enterprise connectivity and metro access network issues.

The main differences between fiber optic and free space communications is that in the former no two lightpaths can share the same wavelength but in FSO no two lightpaths can share the same transmitter and receiver; in fiber optic there is guided medium where as in FSO infrared light is used and line of sight is required to establish a link. In fiber optic direct connection is with adjacent neighbors where as in FSO it can connect to any node that is within certain range with line of sight. Furthermore, in FSO, tracking is introduced to improve the blocking performance [21]. Also, in FSO networks, failures can arise due to poor weather conditions or vibrations of structures which host transmitters and receivers [22, 23]. The references cited so far have treated multichannel multihop lightwave networks to exploit the wide bandwidth of the common transmission medium in fiber optic communications. The problem of dynamic reconfiguration in FSO networks has not been studied.

A scheme that uses tracking at different directions to reduce blocking and increase the recovery of failed traffic. The performance of different schemes are evaluated and compared using three different embodiments. OPNET-based simulations reveal that, if tracking is introduced at different directions even using same number of transmitters and receivers, then blocking can be reduced and considerably larger amount of failed traffic can be recovered.

The objective of dynamic routing is to achieve and maintain the required quality of service (QoS). Any dynamic routing system that attempts to achieve QoS with the optimal use of the resources by rerouting the traffic according to the demand and using tracking transceivers must demonstrate that the mechanism can still meet the current offered load with QoS, as well as changing load in the immediate future. The blocking performance and the latency must be within acceptable limits, impact on performance effects and increase in complexity must be minimal, and fault tolerance must not be sacrificed. The mathematical formulation must produce a feasible network topology that can route to all hosts, and be able to scale to a network with tens of thousands of nodes.

Dynamically optimizing the network under changing traffic and failure patterns is possible due to the flexibility offered by the M×M switching architecture and automatic tracking and dynamic routing capabilities as presented. In certain embodiments of the present disclosure, M×M configuration refers to a node capable of transmitting and receiving over M different physical paths or wavelengths. Whenever the quality of an existing link deteriorates due to increasing traffic, physical failures or weather conditions such as fog, it is assumed that the transmitter/receiver has the ability to orient itself in free space towards another transmitter/receiver. Transceivers with the ability to dynamically reorient themselves are referred to as tracking transceivers.

In certain embodiments of the present disclosure, the static architecture of FSO transceiver is modified and tracking transceivers capable of aligning themselves in different directions are introduced. With this modification the orientation of physical link can be changed and optimized according to the traffic demand and topology changes. This disclosure also focuses on designing the optimal logical topology for FSO using tracking transmitters and receivers.

In certain embodiments, the present disclosure adapts and modifies the formulation of [17] and develops MILP formulation to design the optimal logical topology depending on traffic and available resources for free space optical communications with mesh architecture. The mathematical formulation developed here may also be applied to other topologies. The objective of the mathematical formulation is to develop logical topology that minimizes congestion. The resulting logical topology reflects the traffic intensities between the source destination pairs. Traffic intensity refers to average arrival of packets from a source node that is destined to particular destination node. The objective function also eliminates the bottlenecks of electronic processing at intermediate nodes, thereby establishing a direct lightpath or logical link between the nodes with high traffic intensity. A single lightpath or logical link is a combination of one or more physical links using transmitter and receiver with same wavelength such that no optical to electrical and electrical to optical conversion is required at the intermediate nodes. In this disclosure, the terms logical link and lightpath are used interchangeably. Note that it is not necessary to establish a single lightpath between every source and destination pairs. To establish a route between a source node and a destination node, two or more lightpaths may be used in which case the availability of intermediate optics/electronics is assumed that facilitates wavelength conversion. Each node can serve as a source node, destination node or an intermediate node or as a combination of any of these. The objective function of this disclosure seeks to minimize the maximum traffic flowing in any of the derived logical topology. With such objective function the transmitter and receiver assignment and the routing remain fairly stable even when the traffic matrix is scaled up, thereby avoiding frequent reconfiguration of the logical topology. The blocking performance and the survivability after a network failure are evaluated via simulation.

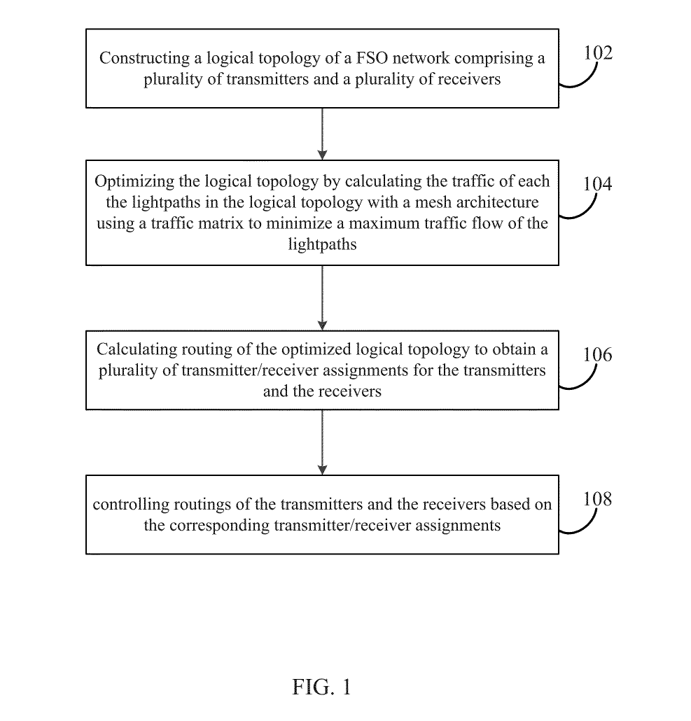

In one aspect of the present disclosure, a method for automatic tracking and dynamic routing for free space optical (FSO) communication is provided. FIG. 1 shows a method for automatic tracking and dynamic routing for free space optical (FSO) communication according to one embodiment of the present disclosure. It should be appreciated that the steps as shown in FIG. 1, although illustrated and described in a certain sequence, may be interchanged and are thus not intended to limit the performance of the method.

As shown in FIG. 1, at step 102, a logical topology of a FSO network is constructed. The FSO network includes a plurality of transmitters and a plurality of receivers, and each of the transmitters and each of the receivers is assigned with a wavelength to form a plurality of physical links between the transmitters and the receivers, where each of the physical links is formed between one of the transmitters and one of the receivers being assigned with the same wavelength. In certain embodiments, the logical topology includes: (i) a plurality of nodes, each representing at least one of the transmitters and at least one of the receivers; and (ii) a plurality of logical links interconnecting the plurality of nodes, where each of the logical links represents a lightpath having a traffic thereon and comprises one or more of the physical links. In other words, the terms “logical links” and “lightpaths” are interchangeable. In certain embodiments, the transmitters and the receivers of the FSO network may be arranged in a variety of ways. For example, the FSO network may include M of the transmitters and M of the receivers in an M×M configuration, where M is a positive integer. In certain embodiments, each of the nodes is configured to communicate with at least one of the other of the nodes via at least one of the lightpaths.

At step 104, the logical topology is optimized by calculating the traffic of each the lightpaths in the logical topology with a mesh architecture using a traffic matrix to minimize a maximum traffic flow of the lightpaths. In certain embodiments, the optimizing the logical topology is performed using a mixed integer linear programming (MILP) formulation.

At step 106, routing of the optimized logical topology is calculated to obtain a plurality of transmitter/receiver assignments for the transmitters and the receivers. In certain embodiments, the calculating routing of the optimized logical topology is performed by generalized multi-protocol label switching (GMPLS) using a routing protocol and a signaling protocol. In one embodiment, the routing protocol may be open shortest path first with traffic engineering (OSPF-TE), and the signaling protocol may be resource reservation protocol with traffic engineering (RSVP-TE).

Then, at step 108, routings of the transmitters and the receivers are controlled based on the corresponding transmitter/receiver assignments.

In certain embodiments, for each of the logical links, the nodes being interconnected by the logical link comprises a source node and a destination node, and in certain embodiments, the node may further include one or more intermediate nodes. In certain embodiments, for each of the nodes, a number of the lightpaths originating from the node is no greater than a number of transmitters being represented by the node, and a number of the lightpaths terminating at the node is no greater than a number of receivers being represented by the node.

In certain embodiments, the method further includes: in response to detecting a failure at a node or a physical link of the FSO network, re-performing steps (b)-(d) to re-optimize the logical topology of the FSO network with the failure.

In certain embodiments, each of the nodes may be configured to communicate with each other via one or more lightpaths, including the steps of: receiving a request to set up a unidirectional connection, calculating a route using the information provided by the routing protocol, triggering a signaling session and initiating the signaling protocol to send a path message along the found route, forwarding the path message by the signaling protocol towards the destination, sending a path error message back to the source node if blocking occurs, initiating a resv message to reserve resources along the reverse of the route traversed by the path message if the path message arrives at the destination node, sending a resv error message towards the source and a resv tear message towards the destination if blocking occurs, establishing a connection between the source and the destination nodes if no blocking occurs, detecting the failure and sending notify message to all other nodes by the node closest to the failure, looking for another available route by initiating the signaling protocol to reserve a route by the source node if it receives the notify message.

In certain embodiments, the path message carries Explicit Route (ER) object and Label Set (LS) object, wherein ER carries the route that path message follows and LS carries the set of available transceivers that can be selected to establish a connection.

Another aspect of the present disclosure relates to a transceiver system for automatic tracking and dynamic routing for free space optical (FSO) communication to reduce the blocking probability and increase the percentage recovery of traffic.

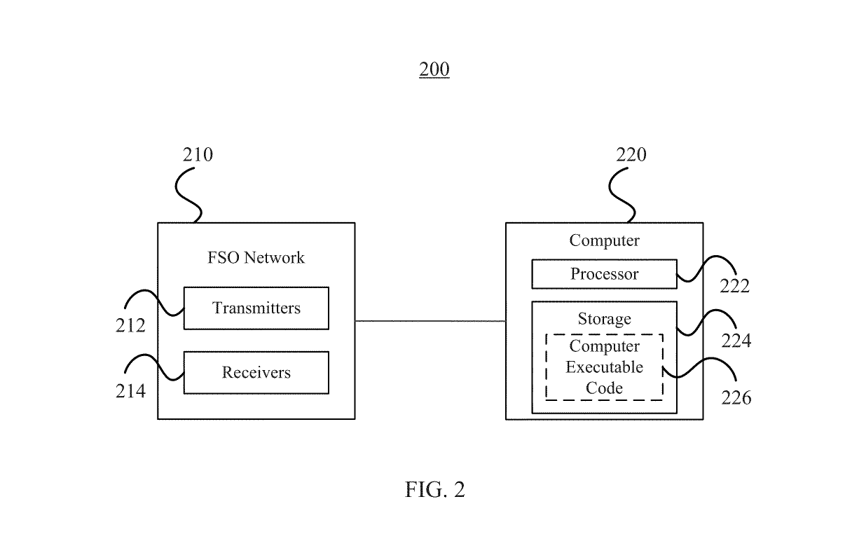

FIG. 2 shows a transceiver system for automatic tracking and dynamic routing for FSO communication according to one embodiment of the present disclosure. As shown in FIG. 2, the system 200 includes a FSO network 210 and a computer 220. It should be appreciated that the components of the system as illustrated in FIG. 2 are shown in blocks without specifying and limiting the interconnection between the components or their sub-components.

The FSO network 210 includes a plurality of transceivers, including a plurality of transmitters 212 and a plurality of receivers 214. Each of the transmitters 212 and each of the receivers 214 may be assigned with a wavelength to form a plurality of physical links between the transmitters 212 and the receivers 214.

The computer 220 is a computing device to control the transmitters 212 and the receivers 214 of the FSO network 210. As shown in FIG. 2, the computer 220 includes a processor 222 and a storage 224. In certain embodiments, the computer 220 may include other hardware components and software components (not shown) to perform its corresponding tasks. Examples of these hardware and software components may include, but not limited to, other required memory, interfaces, buses, Input/Output (I/O) modules and peripheral devices. In certain embodiments, the computer 220 may be implemented by a computer system including multiple computing devices. For example, a client-server computer system may be provided with multiple hardware components being separately formed and interconnected by a network.

The processor 222 is a host processor which is configured to control operation of the computer 220. In certain embodiments, the processor 222 may be a central processing unit (CPU). In certain embodiments, the computer 222 may run on multiple CPUs as the host processor.

The storage 224 may be a non-transitory non-volatile data storage media for storing software codes, such as the computer executable code 226. Examples of the storage 224 may include flash memory, memory cards, USB drives, hard drives, floppy disks, optical drives, or any other types of suitable non-volatile data storage devices. In certain embodiments, the storage 224 may be located within the computer 220, or may be provided as a portable storage or an external storage device being connected to the computer 220 through a cable or other interfaces.

The computer executable code 226 is the software code which, when executed at the processor 222, is configured to perform the method as illustrated in FIG. 1 to control the transmitters 212 and the receivers 214 of the FSO network 210. Details of the method have been described above and are hereinafter not elaborated. In certain embodiments, the computer executable code 226 may be in the form of software in a portable storage 224 or firmware in a programmable chip.

In certain embodiments, a failure may occur in the FSO network 210. The failure may be related to a transmitter or receiver at a node, or may be related to a link between the nodes. In response to detecting a failure of the transmitter or receiver at a node, the system 200 may send a notifying signal to all the nodes affected by the transmitter or receiver failure, and then initiate a recovery process to re-optimize and reconfigure the logical topology and rerouting the existing traffic. In response to detecting a failure of a link, the system may send a notifying signal to source nodes that generated the affected traffic by the node or nodes next to the link failure, and then initiate the recovery process by the source nodes affected by the link failure to re-optimize and reconfigure the logical topology and rerouting the existing traffic.

In certain embodiments, optimizing the logical topology for an asymmetric traffic comprises at least of determining the asymmetric traffic and using all available transmitters and receivers and establishing at least one lightpath per node pairs for the asymmetric traffic.

In yet another aspect, the present disclosure relates to a non-transitory computer readable medium storing computer executable code. In certain embodiments, the computer executable code may be the computer executable code 226 as described above for performing the method as described above. In certain embodiments, the non-transitory computer readable medium may include, but not limited to, the storage 224 as described above, or any other storage media of the computer 220.

As described above, the logical topology of the FSO network being constructed by the system may include a plurality of nodes and a plurality of logical links (i.e., lightpaths). Examples of the logical topology and other features of the disclosure will be hereinafter described in details.

### Logical Topology Optimization

### System Architecture

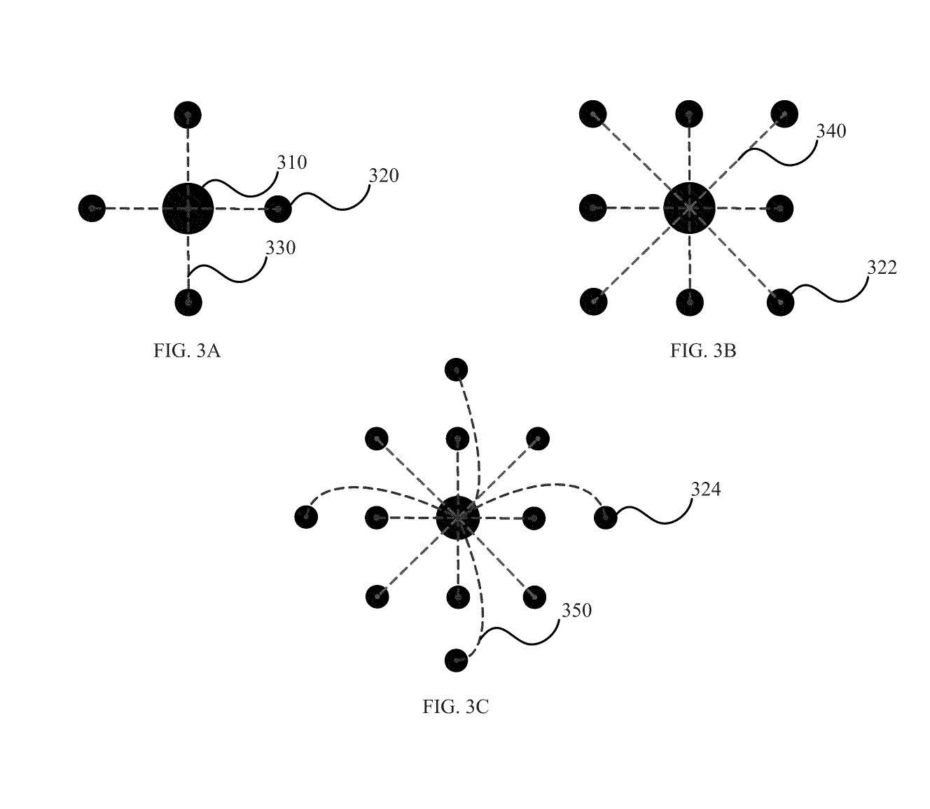

FIGS. 3A-3C shows the architecture of tracking FSO that adapts to dynamic environment to find the available links from source to destination. The architecture uses an M×M configuration of transmitters and receivers that can rotate at different angles to establish a connection. If logical topology is not formulated, electrical-to-optical and optical-to-electrical conversion may be required at each intermediate node along the route. Not being fast enough, the electronic processing (electrical to optical and optical to electrical conversion) creates bottleneck at intermediate nodes thereby reducing the throughput. Using the central node as the source node or the transmitting station, three different embodiments may be simulated as follows.

### Embodiment I

FIG. 3A schematically shows the architecture of tracking FSO according to one embodiment of the present disclosure, where a central node may track and switch the traffic to other nodes at a distance of D meters that are in line of sight with it. As shown in FIG. 3A, the nodes include a central node 310 (which serves as the source node or the transmitting station) and other nodes 320. The central node 310 is able to communicate with other nodes via lightpaths 330, and track and switch the traffic to other nodes 320 at a distance of D meters that are in line of sight with it. It has the capability to switch the traffic at full rate.

### Embodiment II

FIG. 3B schematically shows the architecture of tracking FSO according to one embodiment of the present disclosure, where a central node may track and switch the traffic to any other nodes at D or √2D from it and are in line of sight. As shown in FIG. 3B, in addition to the central node 310 (which serves as the source node or the transmitting station) and the nodes 320 at a distance of D meters from the central node 310, the nodes further include nodes 322 at a distance of √2D meters from the central node 310. The central node 310 may track and switch the traffic to the nodes 320 at D meter away from it via lightpaths 330, or to the node 322 at √2D meter away from it via lightpaths 340. It has the capability to switch the traffic at full rate.

### Embodiment III

FIG. 3C schematically shows the architecture of tracking according to one embodiment of the present disclosure, where a central node may track and switch traffic directly to other nodes that are at D, √2D or 2D meters away from it and are in line of sight with it. As shown in FIG. 3C, in addition to the central node 310 (which serves as the source node or the transmitting station), the nodes 320 at a distance of D meters from the central node 310, and the nodes 322 at a distance of √2D meters from the central node 310, the nodes further include nodes 324 at a distance of 2D meters from the central node 310. The central node 310 may track and switch the traffic to the nodes 320 at D meter away from it via lightpaths 330, or to the node 322 at √2D meter away from it via lightpaths 340, or to the nodes 324 at 2D meters away from it via lightpaths 350. In this embodiment, for the sake of simplicity, full data rate is assumed for all cases. Line of sight communication is assumed between the nodes 324 that are 2D meter away from each other and representation in FIG. 3C is only conceptual.

### Problem Formulation

In certain embodiments of this disclosure, a precise formulation of logical topology design problem is presented as the MILP problem for free space optical communication network without wavelength converters. The problem formulation takes into account the maximum number of transmitters/receivers available at a node, the maximum number of hops permitted and the wavelength continuity constraint.

In one embodiment, the MILP formulation comprises creating a transceiver architecture with M transmitters and M receivers in a M×M configuration that can dynamically orient themselves at different direction to establish a link between two transceivers.

Following notations are used:

s, d correspond, respectively, to source and destination nodes;

i, j correspond, respectively, to the originating and terminating nodes in a lightpath;

q represents the q^{th} multiple lightpath between nodes terminating a lightpath;

l, m represent endpoints of a possible physical link;

k transmitter or receiver with wavelength k when used as a superscript.

The following quantities are defined so that the model can be developed:

Traffic Matrix represents the average traffic between every pair of nodes in the physical topology. Let N represent the number of nodes in the network. The traffic matrix is defined as an N×N matrix in which the (s,d)-th entry λ^{sd} represents the average arrival rate of connection oriented multiprotocol label switching (MPLS) packets from source node s that are destined to destination node d.

Link Indicator Pₗₘε{0, 1} is a binary variable that represents whether a physical link between a node l and node m in a physical topology is feasible or not. The value of Pₗₘ is 1 if it is possible to establish a link between l and m in the physical topology and 0 otherwise.

Maximum hop matrix (Hₘₐₓ) denotes the maximum number of hops that a lightpath between the node i and node j is permitted to take. The hop matrix is represented by [H_{i,j}].

W represents number of transmitters/receivers with different wavelengths.

Δᵢ^{(t)} and Δᵢ^{(r)} represent the number of transmitters and receivers, respectively, at any node i.

### Variables

Lightpath indicator variable is a binary variable that indicates whether a q^{th} multiple lightpath exists between node i to another node j and is denoted by b_{q}(i,j). If there exists a q^{th} multiple directed edge (i,j) in the logical topology, then b_{q}(i,j)=1; otherwise b_{q}(i,j)=0.

The lightpath wavelength variable represented by C^{(k,q)} (i,j) is a binary variable that indicates whether a particular transmitter and receiver with wavelength k has been used between node i and node j in the q^{th} lightpath. C^{(k,q)}(i,j)=1, if the q^{th} lightpath between node i and node j uses a transmitter and receiver with wavelength k; otherwise C^{(k,q)}(i,j)=0.

Another binary variable known as link-lightpath wavelength variable represented by C_{l,m}^{k,q}(i,j) is introduced to indicate if the q^{th} lightpath between node i and node j uses wavelength k and is routed through the physical link (l,m). C_{l,m}^{k,q}(i,j)=1, if the q^{th} lightpath between nodes i and j uses a transmitter and receiver with wavelength k and passes through the physical link (l,m); otherwise C_{l,m}^{k,q}(i,j)=0.

Traffic Load on Logical Topology:

when lightpaths are established over a physical topology, the traffic from source nodes to the destination nodes are routed via a combination of one or more lightpaths. The aggregate traffic from all source destination pairs in a q^{th} lightpath between node i and node j is referred to as the offered load to the lightpath and is denoted by f^{q}(i,j). The component of the offered load to a q^{th} lightpath due to traffic from source node s to destination node d is denoted by f_{(s,d)}^{(q}(i,j). The maximum traffic flow on any lightpath represents the extent of congestion in the network and is given by fₘₐₓ=max_{(i,j),q}(f^{q}(i,j)).

In certain embodiments, the number of transmitters and receivers at each node and the traffic matrix representing long term average flow between the nodes are given. Since electronic processing/switching at each node is a slower and expensive process and is proportional to the network congestion, it is reasonable to minimize network congestion on such networks. The main idea is to establish a lightpath between two nodes if there is high traffic between them that avoids the electronic processing/switching so as to ultimately reduce congestion in the network. The transmitters and receivers are assumed to be not tunable to other wavelengths.

The logical topology design and routing problem can be formulated as the following MILP.

Objective: Minimize the maximum traffic flow on any lightpath and is stated as

minimize(fₘₐₓ) (1)

subject to the following constraints:

### Degree Constraints

Σ_{q=1}^{Q}Σⱼb_{q}(i,j)≦Δᵢ^{(t)}, ∀i (2)

Σ_{q=1}^{Q}Σⱼb_{q}(j,i)≦Δᵢ^{(r)}, ∀i (3)
b_{q}(i,j)ε{0,1}, where i, jε{1, 2, . . . N}

The degree constraints given in (2) and (3) constrain the logical topology to a given logical degree. The number of lightpaths originating from and terminating at node “i” are, respectively, less than or equal to the number of transmitters and receivers at that node. It is assumed that every node in the network has the same number of transmitters and receivers. The argument Q represents the maximum number of edges between the node pairs in the logical topology.

### Wavelength Continuity Constraints

a. Σₖ₌₀^{W-1}C^{(k,q)}(i,j)=b_{q}(i,j), ∀(i,j) and q (4)

If the q^{th} lightpath between node i and node j, (b_{q}(i,j)) exists, then transmitter or receiver with the same wavelength is assigned to the q^{th} lightpath among W possibilities in all physical links. In this embodiment transmitter and receiver with only one particular wavelength is used, i.e., transmitters and the receivers with the same wavelength should be used along the route of the lightpath to avoid optical to electrical and electrical to optical conversion in a single lightpath.

b. C_{l,m}^{k,q}(i,j)≦C^{(k,q)}(i,j), ∀(i,j),(l,m),q and k (5)

Only those C_{l,m}^{k,q}(i,j) could be non zero for which the corresponding C^{(k,q)}(i,j) variables are non zero. If the transmitter and receiver at a node with wavelength k is chosen for the q^{th} lightpath between (i,j), then C^{(k,q)}(i,j)=1. Then for all other transmitters or receivers with wavelengths w≠k; C^{(w,q)}(i,j)=0, which implies that C_{l,m}^{w,q}(i,j)=0 for all (l,m) and w≠k.

Observation:

If a lightpath between (i,j) that uses transmitter and receiver with wavelength k exists, and passes through (l,m), C_{l,m}^{k,q}(i,j)=1; otherwise C_{l,m}^{k,q}(i,j)=0.

If a lightpath (i,j) does not exist, then C_{l,m}^{k,q}(i,j)=0.

### Transmitter and Receiver Clash Constraints

In FSO network with tracking transceivers no two lightpaths traversing through the physical node l will be assigned the same optical transmitter (laser) or same optical receivers. Alternatively, a transmitter or receiver with wavelength k can be used by only one lightpath traversing that particular node.

Σ_{q}Σ₍ₘ₎Σ_{(i,j)}C_{l,m}^{k,q}(i,j)≦1, ∀(l),k (6)

The above equation expresses the fact that at most one lightpath can use the optical transmitter (laser) with wavelength k at a node l.

Σ_{q}Σ₍ₘ₎Σ_{(i,j)}C_{m,l}^{k,q}(i,j)≦1, ∀(l),k (7)

The above equation expresses the fact that at most one lightpath can use the optical receiver with wavelength k at a node l.

### Conservation of Wavelength Constraints

$${\sum }_{k = 0}^{W - 1} {\sum }_{l} {C}_{l , m}^{k , q} ( i , j ) {P}_{l , m} - {\sum }_{k = 0}^{W - 1} {\sum }_{l} {C}_{m , l}^{k , q} ( i , j ) {P}_{m , l} \\ = \{ \begin{matrix}{b}_{q} ( i , j ) & If m = j \\ - {b}_{q} ( i , j ) & If m = i \\ 0 if m \neq i & and m \neq j\end{matrix} \} , ∀ ( i , j ) , m and q \qquad ( 8 )$$

The above equation ensures that the transmitter or receiver with the same wavelength is reserved at every node through which a lightpath b_{q}(i,j) traverses. This means if the q^{th} lightpath between node i and node j uses transmitter and receiver with wavelength k, then by conservation of wavelength constraints there exists a physical link between node i and node j with wavelength k assigned to it.

### Traffic Routing Constraints

f_{(s,d)}^{q}(i,j)≦b_{q}(i,j)λ^{(s,d)}, ∀(i,j),q,(s,d) (9)

The above constraint represents the fact that the component of traffic on a lightpath due to a particular source destination pair is possible only if the lightpath exists in the logical topology, and cannot be more than the total traffic between that source destination pair.

f^{q}(i,j)=Σ_{∀(s,d)}f_{(s,d)}^{q}(i,j), ∀(i,j),q (10)

The above equation ensures that the total traffic on a lightpath is the sum of the traffic component on that lightpath due to all the different pairs of source and destination nodes.

f^{q}(i,j)≦fₘₐₓ, ∀(i,j),q (11)

The above equation defines the network congestion; it states that the load on any lightpath is not greater than the maximum load fₘₐₓ, which is the objective function to be minimized.

### Flow Conservation Constraints

$${Σ}_{q} {Σ}_{j} {f}_{( s , d )}^{q} ( i , j ) - {Σ}_{q} {Σ}_{j} {f}_{( s , d )}^{q} ( j , i ) = \{ \begin{matrix}{λ}^{( s , d )} & if s = i \\ - {λ}^{( s , d )} & if d = i \\ 0 , & if s \neq i and d \neq i , ∀ ( s , d )\end{matrix} \qquad ( 12 )$$

The flow conservation constraints specify that, for each source-destination pair (s,d), the traffic flowing into a node balances the traffic flowing out of it.

### Hop Bound Constraints

Σ_{l,m}C_{l,m}^{k,q}(i,j)≦H^{q}(i,j), ∀(i,j),q and k (13)

The lightpath is the combination of physical links (l,m). The hop bound constraint express the fact that the summation of the number of hops along a lightpath is bounded by H^{q}(i,j).

### Complexity

In the above MILP formulation, the number of constraints and the number of variables grow approximately as O(N³×W×number of edges×multiplicity factor). The model is suitable for moderate sized networks.

### Routing

In certain embodiments, dynamic connection request (for example packet switched connection oriented request that requires QoS) in a FSO network may be handled in a centralized or distributed manner. To deal with the increasing demand of bandwidth intensive applications and to support dynamic resource allocation, a distributed scheme is required. In addition to this, a unified control plane is essential for FSO networks since there exists the possibility of switching occurring in multiple layers. Generalized multi-protocol label switching (GMPLS) [18], developed by the Internet Engineering Task Force (IETF), is such a unified control plane protocol that maintains a common control plane instance for a network hosting multiple switching layers and is a suitable candidate for FSO networks. GMPLS can be deployed in FSO where transmitters and receivers are used to establish low level point-to-point links for the transmission of packets between high performance routers. In optical internet, GMPLS routers translate label assignments into corresponding transmitter/receiver assignments and different network nodes communicate with each other via one or more lightpaths. GMPLS employs open shortest path first with traffic engineering (OSPF-TE) as the routing protocol and resource reservation protocol with traffic engineering (RSVP-TE) as the signaling protocol. It is assumed that signaling is out of band. In OSPF-TE, each node shares information about network topology with its neighboring nodes, which each node uses to compute paths to every other node in the network. In a complementary manner, RSVP-TE utilizes the paths computed by the nodes to send signaling messages and establish connections. This paper adapts the destination initiated reservation (DIR) scheme proposed in [19]. In DIR, OSPF-TE requires each node to share with its neighbors summarized information of network topology. It advertises a link from a particular node to another node as alive as long as some free capacity is available in that link.

If a node receives a request to set up a unidirectional connection, a route is calculated using the information provided by routing protocol. The signaling session is triggered and it will initiate RSVP-TE protocol to send path message along the found route. RSVP-TE forwards a path message towards the destination. The path message carries Explicit Route (ER) object and Label Set (LS) object [20]. ER carries the route that path message follows and LS carry the set of available transceivers that can be selected to establish a connection. If none of the transceivers with free capacity is available, then blocking occurs, and a path error message is sent back to the source node. If the path message arrives at the destination node, then the node will initiate a resv message to reserve resources along the reverse of the route traversed by the path message. If the resv message is unable to reserve resources at a node, possibly due to reservation of resources by other requests, then the call will be blocked. If blocking occurs, a resv error message is sent towards the source and a resv tear message towards the destination. If no blocking occurs, then resv message arrives at the node indicating that resources have been reserved and a connection has been established between the source and the destination nodes. In embodiment of failure, the node closest to the failure is responsible for detecting the failure and sending notify message to all other nodes. After the source node receives the notify message, it will look for another available route by initiating RSVP-TE protocol to reserve a route. Note that, in this paper to analyze the mean recovery ratio for different embodiments after the failure, the occupied resources affected by failure are not released to reestablish affected connections due to the added complexity. The source node attempts to recover the affected connections in a single attempt.

### Example for Different Embodiments

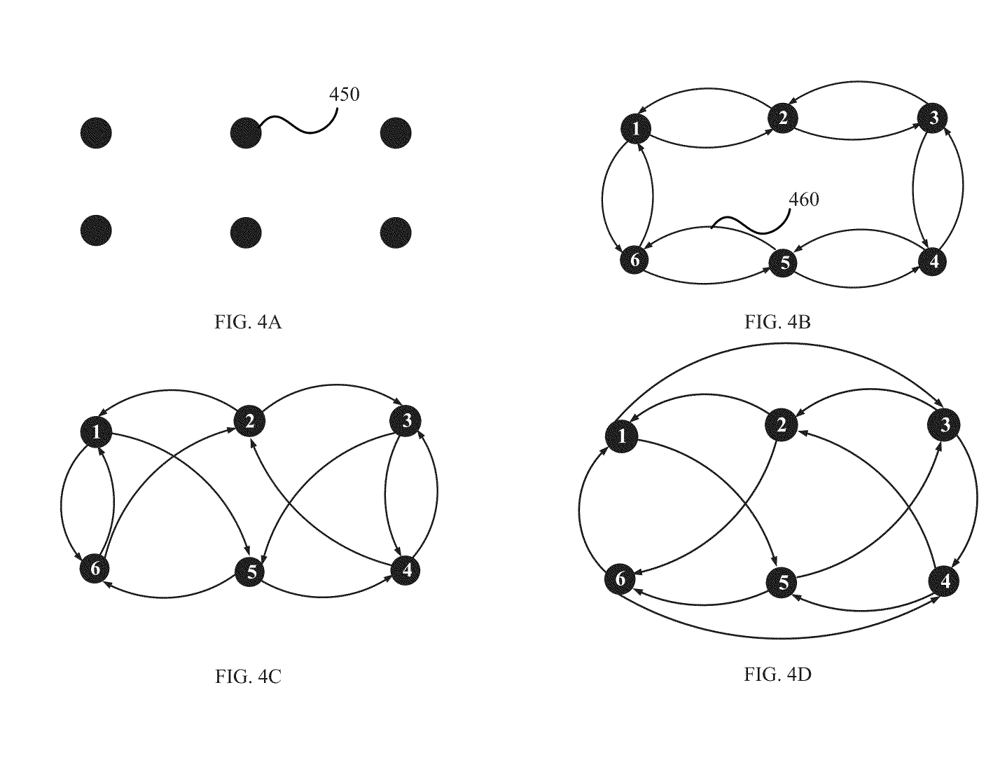

Different embodiments are considered to demonstrate the performance of the tracking FSO. First, MILP formulation is solved using CPLEX to generate the optimum logical topology. The optimum logical topology is then used in simulation to evaluate the blocking performance for different embodiments. OSPF-TE shares with its logical neighbors the summarized information of logical topology, and RSVP-TE use the path computed in the logical topology to send signaling message and establish the connection. The logical neighbors are the nodes that are connected by a single lightpath. Table I and Table II demonstrate the sample uniform traffic matrix and non-uniform traffic matrix respectively. Each entity in the table represents the average arrival rate of connection oriented packet data. FIG. 4A schematically shows an example of the 6-node network utilized in the MILP formulation simulation using CPLEX according to one embodiment of the present disclosure. Based on the 6-node network as shown in FIG. 4A, FIGS. 4B, 4C and 4D, respectively, show the optimal logical topologies from CPLEX according to FIGS. 3A-3C for the traffic matrix as shown in Table I according to different embodiments of the present disclosure. As shown in FIGS. 4B-4D, the arrows indicate the direction of the traffic flow 460.

The performance of tracking FSO is simulated using the 6 node mesh network shown in FIG. 4A using OPNET. Once the logical topology is determined, GMPLS is assumed as a control plane protocol. OSPF-TE is selected for the routing protocol and RSVP-TE is used for signaling propose. As traffic conditions change or the topology changes, CPLEX is used to generate optimal logical topology. In order to evaluate the blocking performance, traffic is generated according to traffic matrix shown in Table I and Table II. Since the topology in OPNET is a derived logical topology for a given traffic matrix, each link is a logical link or a lightpath. Hence, in OPNET simulation the route with less number of lightpaths than another is selected with a higher priority to establish the connection for each request. The arrival of requests for connections follows a Poisson process with exponential resource reservation time. Traffic in the network is varied by varying the ratio of resource reservation time to inter-arrival

TABLE I
Traffic Matrix

| Nodes | 1 | 2 | 3 | 4 | 5 | 6 |
|---|---|---|---|---|---|---|
| 1 | 0.000 | 0.038 | 0.037 | 0.050 | 0.056 | 0.068 |
| 2 | 0.027 | 0.000 | 0.014 | 0.016 | 0.010 | 0.058 |
| 3 | 0.004 | 0.032 | 0.000 | 0.045 | 0.014 | 0.007 |
| 4 | 0.036 | 0.046 | 0.035 | 0.000 | 0.030 | 0.048 |
| 5 | 0.034 | 0.012 | 0.037 | 0.062 | 0.000 | 0.017 |
| 6 | 0.067 | 0.028 | 0.012 | 0.046 | 0.014 | 0.000 |

TABLE II
Asymmetric Traffic Matrix

| Nodes | 1 | 2 | 3 | 4 | 5 | 6 |
|---|---|---|---|---|---|---|
| 1 | 0.000 | 0.000 | 0.000 | 0.000 | 0.000 | 0.000 |
| 2 | 0.136 | 0.000 | 0.000 | 0.097 | 0.000 | 0.000 |
| 3 | 0.000 | 0.000 | 0.000 | 0.000 | 0.388 | 0.194 |
| 4 | 0.058 | 0.000 | 0.050 | 0.000 | 0.000 | 0.000 |
| 5 | 0.000 | 0.023 | 0.000 | 0.000 | 0.000 | 0.027 |
| 6 | 0.000 | 0.000 | 0.016 | 0.012 | 0.000 | 0.000 |

time. Bandwidth required for each connection is assumed to be 6.25% of the capacity of a single wavelength.

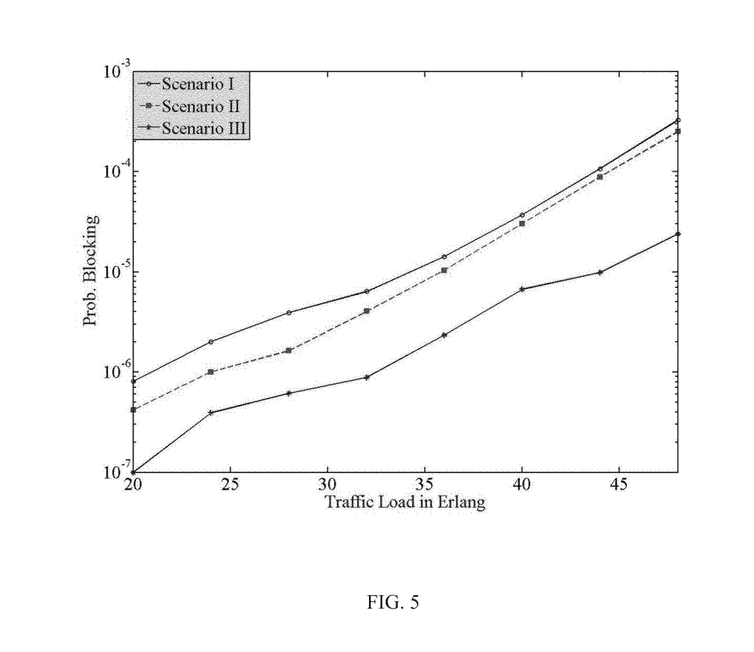

FIG. 5 shows blocking performance for the three embodiments for the sample uniform traffic matrix as shown in FIGS. 3A-3C according to certain embodiments of the present disclosure. The data of the traffic matrix is given in Table I. Specifically, the logical topologies as shown in FIGS. 4B, 4C and 4D are used as the embodiments to evaluate the blocking performance. Blocking in the embodiment of FIG. 4B is relatively more compared to the embodiments of FIGS. 4C and 4D. In the embodiment of FIG. 4B, the physical link can be established between nodes that are only D meters away, which limits the available routes towards the destination compared to the embodiments of FIGS. 4C and 4D. In the embodiment of FIG. 4C, physical links can also be established between nodes that are √2D meters away, as shown in FIG. 3B. Since more possibilities exist to establish a route from source to destination in the embodiment of FIG. 4C compared to the embodiment of FIG. 4B, it is expected that the blocking in the embodiment of FIG. 4C to be less compared to that in the embodiment of FIG. 4B. For comparison purposes, in the embodiment of FIG. 4D, it is assumed that, in addition to the connections possible in the embodiments of FIG. 4B and FIG. 4C, it is also possible to establish direct connections between any pair of nodes that are at line of sight and at 2D meters away from each other. Since the possibility to establish a route between source and destination is more in the embodiment of FIG. 4D compared to both embodiments of FIG. 4B and FIG. 4C, it is expected that the blocking probability to be the least amongst all the three embodiments. FIG. 5 provides the simulation results for the three embodiments. The results demonstrate almost an order of magnitude improvement in blocking performance with the embodiment of FIG. 4D in comparison to the embodiment of FIG. 4B and a similar improvement over the embodiment of FIG. 4C at high traffic loads.

### Failure Embodiments

### Transmitter or Receiver Failure

This section shows the performance of the proposed M×M tracking transceiver architecture when a single failure occurs at a transmitter or receiver. The performance of the system with optimal logical topology before failure is firstly determined. After a single failure of a transmitter or receiver occurs, the new optimal topology and the corresponding blocking performance is then determined. This helps us to compare the blocking performances before and after failure. To change the logical topology after failure, different existing algorithms can be used to reroute the existing traffic. For the purposes of comparison, a separate simulation embodiment is developed and the performance is evaluated using different logical topologies.

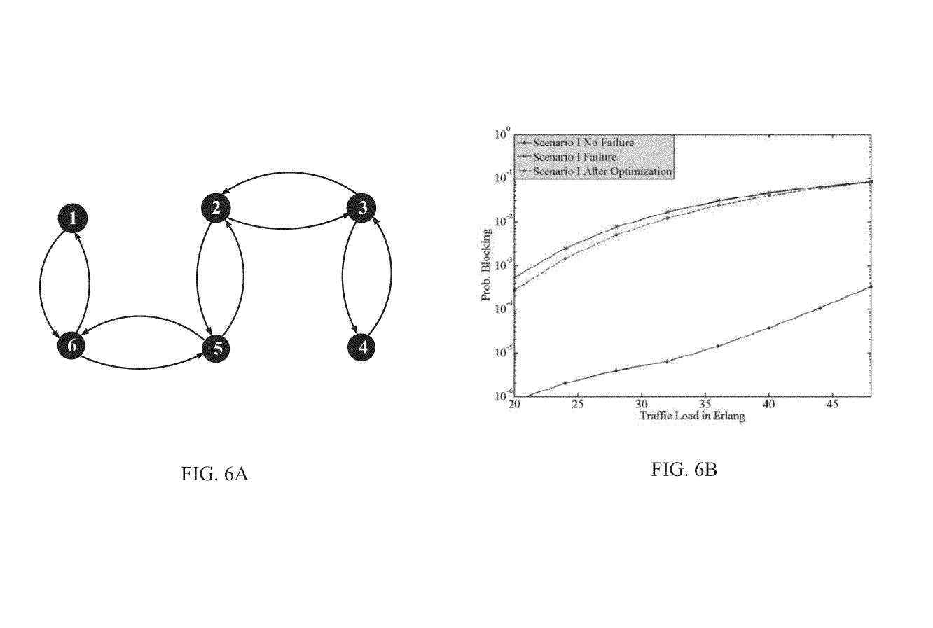

FIG. 6A shows the optimal logical topology according to FIG. 3A for the case after one of the transmitting lasers at node 1 fails according to one embodiment of the present disclosure. FIG. 6B shows comparisons of the blocking performance of the optimal logical topology according to FIG. 3A according to certain embodiments of the present disclosure, including (a) normal conditions without failure, (b) a single failure of a transmitter or receiver at a node and (c) the new optimized logical topology after the failure of a transmitter or receiver. The results show the performance improvement achievable with the use of the tracking transmitter and receiver architecture. It shows that, with a traffic of 20 Erlangs, if there is failure of a single transmitter or receiver, the average probability of blocking is 5.3×10⁻⁴; after optimization the average probability of blocking decreases to 2.7×10⁻⁴, and hence an improvement of 49% is achieved using reconfiguration of logical topology. For the given traffic shown in Table I, the link between node 1 and node 6 is the highest utilized link for the embodiment of FIG. 3A.

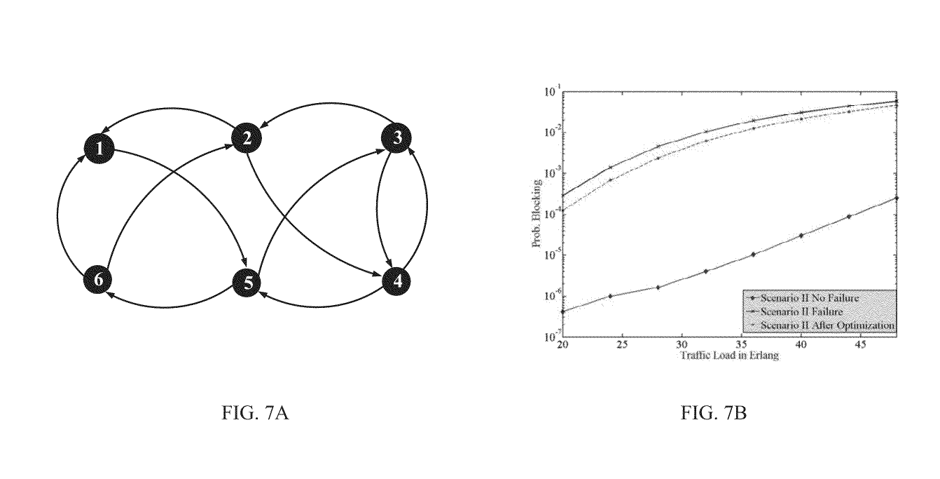

FIG. 7A shows the optimal logical topology according to FIG. 3B after one of the lasers in node 1 fails according to one embodiment of the present disclosure. FIG. 7B shows comparisons of the blocking performance of the optimal logical topology according to FIG. 3B according to certain embodiments of the present disclosure, including (a) normal conditions without failure, (b) a single failure of a transmitter or receiver at a node and (c) the new optimized logical topology after the failure. It shows that, after failure, the performance deteriorates by more than two orders of magnitude but that optimization can improve the performance. Again, with traffic of 20 Erlangs, in the embodiment of FIG. 3B, an improvement of 56% is achieved compared to failure embodiment. Similar to the embodiment of FIG. 3A, in the simulations, a single failure is forced at the transmitter or receiver and observe the performance at different traffic loads.

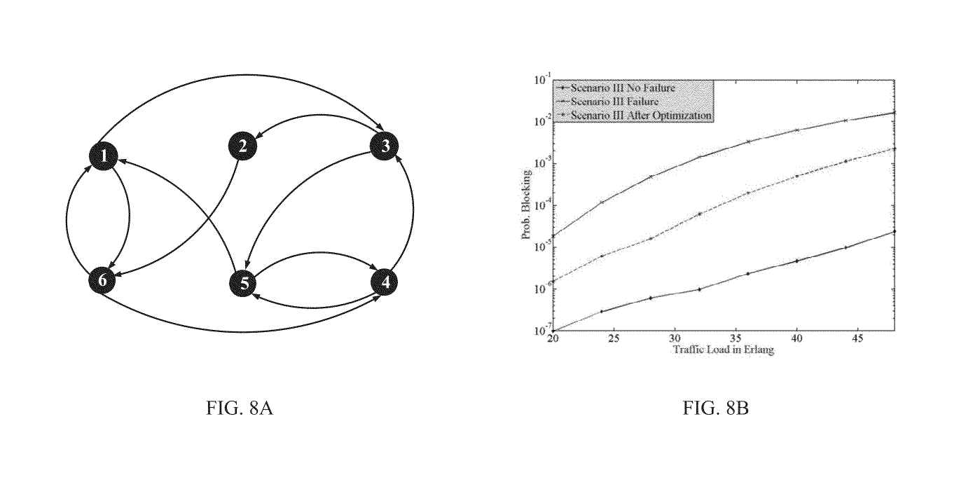

FIG. 8A shows the optimal logical topology according to FIG. 3C after one of the lasers in node 2 fails according to one embodiment of the present disclosure. FIG. 8B shows comparisons of the blocking performance of the optimal logical topology according to FIG. 3C according to certain embodiments of the present disclosure, including (a) normal conditions without failure, (b) a single failure of a transmitter or receiver at a node and (c) the new optimized logical topology after the failure. As was the case previously for embodiments I and II, the results show that with the reconfiguration of logical topology after a failure to be the optimal logical topology, the blocking performance improves. In this embodiment, for the traffic of 20 Erlangs, the improvement is 91%.

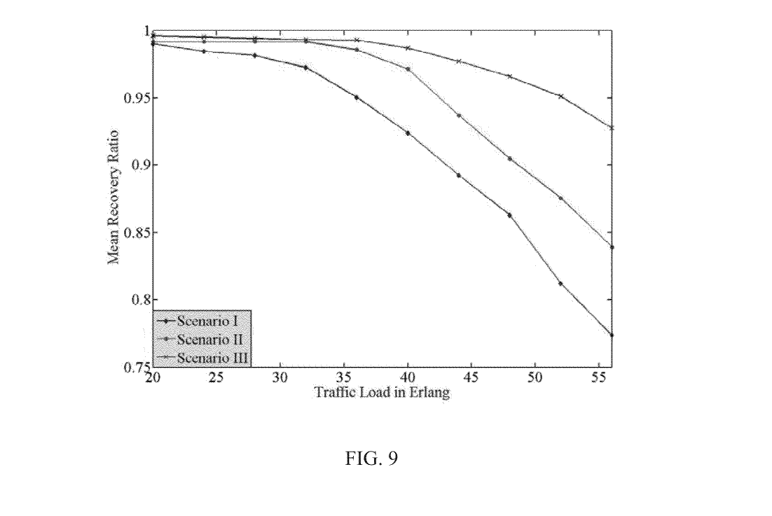

FIG. 9 shows the mean recovery ratio for the three embodiments as shown in FIGS. 3A-3C after the transmitter failure according to certain embodiments of the present disclosure. After the failure the node sends the notify signal to all the nodes and the nodes that are affected by failure initiate the recovery process. The simulations assume that only a single attempt is made to recover the affected traffic. The percentage recovery with the embodiment of the optimal logical topology according to FIG. 3C is greater than that with the embodiments of the optimal logical topology according to FIGS. 3A and 3B. As expected, recovery in the embodiment of FIG. 3B is greater than that of the embodiment of FIG. 3A. For the traffic of 56 Erlangs, the mean recovery ratio for the embodiment of FIG. 3C is 0.92, whereas for the embodiment of FIG. 3B, it is 0.83 and for the embodiment of FIG. 3A the ratio is 0.77.

### Link Failure

FSO system is very sensitive to weather condition such as fog [23]. In such cases, the possibility of a link failure is very high. In this section, the recovery of the traffic after a single link failure is demonstrated. To evaluate the performance, traffic is generated according to the traffic matrix shown in Table I. A single link failure is introduced randomly for all three embodiments. The node next to the failure detects the failure and sends the notify signal to the source nodes that generated the affected traffic. After detecting notify signal, the source node that is affected by failure initiates the recovery process. For the simulation study, the source node attempts to recover the affected traffic in a single attempt. To simplify the simulation, the resources that have been reserved before are not released. Hence the actual percentage recovery will be greater than that portrayed here should the simulations incorporate releasing the reserved resources prior to attempting recovery of affected traffic.

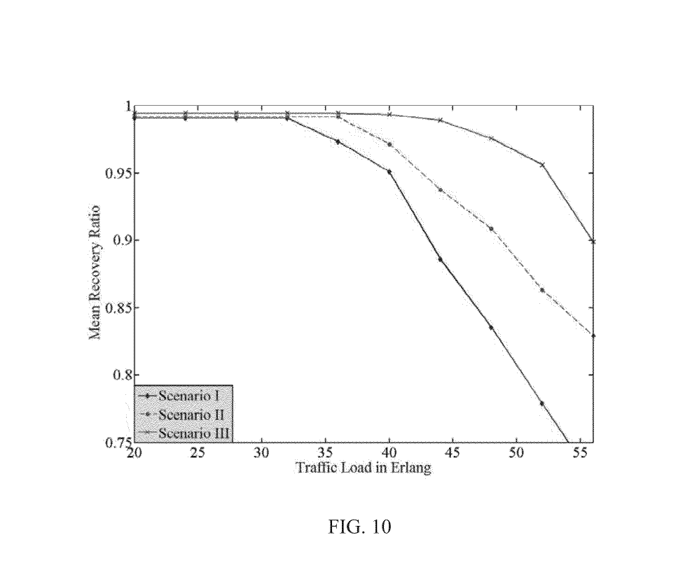

FIG. 10 shows comparison of the simulation results with respect to recovered traffic for three different embodiments as shown in FIGS. 3A-3C with link failure according to certain embodiments of the present disclosure. Since the embodiment of FIG. 3C offers more choices while recovering, the percentage of recovered traffic is greater for this embodiment in comparison to the embodiments of FIGS. 3A and 3B. In the simulation, it is assumed that only one link fails. Similarly, there are more possibilities to establish a physical link with the embodiment of FIG. 3B after a failure than with the embodiment of FIG. 3A and so the percentage of recovered traffic in the embodiment of FIG. 3B is larger compared to the embodiment of FIG. 3A. FIG. 10 shows that for the traffic of 52 Erlangs, the mean recovery ratio for the embodiment of FIG. 3C is 0.95, whereas the mean recovery ratio for the embodiment of FIG. 3B is 0.86 and for the embodiment FIG. 3A the ratio is 0.77.

FIGS. 9 and 10 reveal that, with the embodiments of FIGS. 3A and 3B, more traffic can be recovered with a transmitter failure than with a link failure. With the embodiment of FIG. 3C, however, there is no appreciable difference with either type of failures.

Examples of Embodiments with Asymmetric Traffic

In the embodiments as described above, the traffic is symmetric. Though multiple lightpaths can be established between different node pairs, as illustrated in the preceding sections, the optimum logical topology has only one lightpath between the node pairs. In this section, the asymmetric traffic matrix shown in Table II is considered for the simulations.

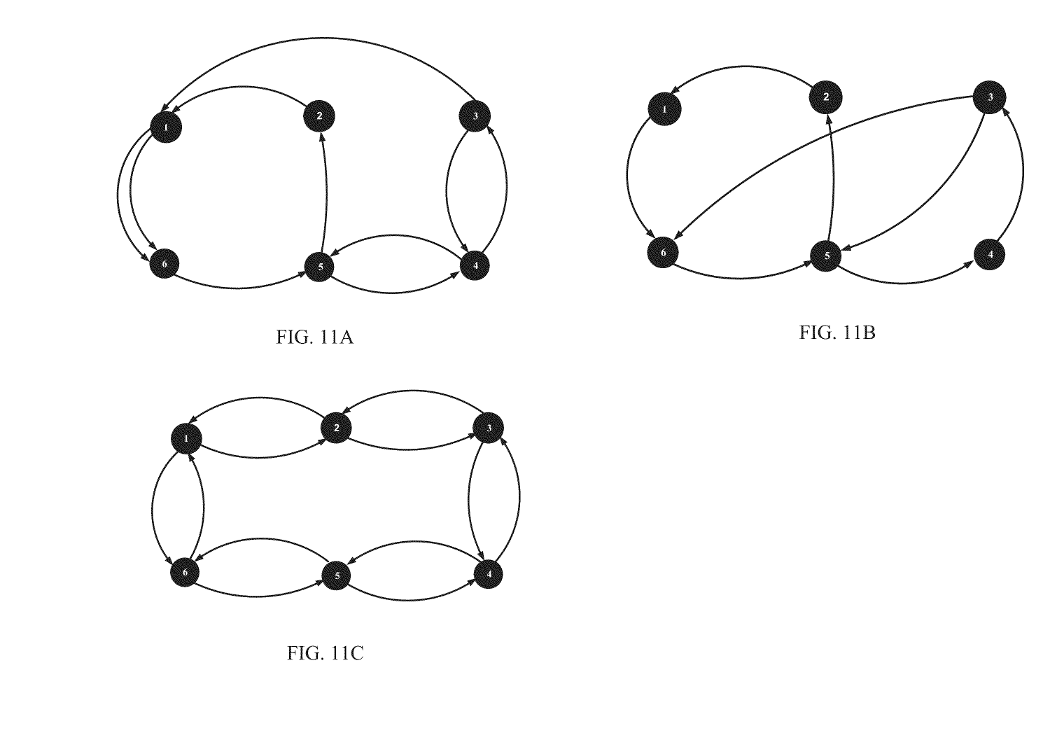

FIG. 11A shows the logical topology according to FIG. 3A for a sample non-uniform traffic matrix according to one embodiment of the present disclosure. In contrast to symmetric traffic, with asymmetric traffic, there are multiple lightpaths between nodes 1 and 6. To study different features, the maximum number of lightpaths between node pairs is restricted to one. FIG. 11B shows the logical topology according FIG. 3A for a sample non-uniform traffic matrix with restriction maximum of one lightpath per source destination pair according to one embodiment of the present disclosure. FIG. 11C shows the logical topology according to FIG. 3A for a sample non-uniform traffic matrix using all transmitter and receiver according to one embodiment of the present disclosure. In these embodiments, the formulas (2) and (3) are modified and are shown below.

Σ_{q=1}^{Q}Σⱼb_{q}(i,j)=Δᵢ^{(t)}, ∀i (14)

Σ_{q=1}^{Q}Σⱼb_{q}(j,i)=Δᵢ^{(r)}, ∀i (15)

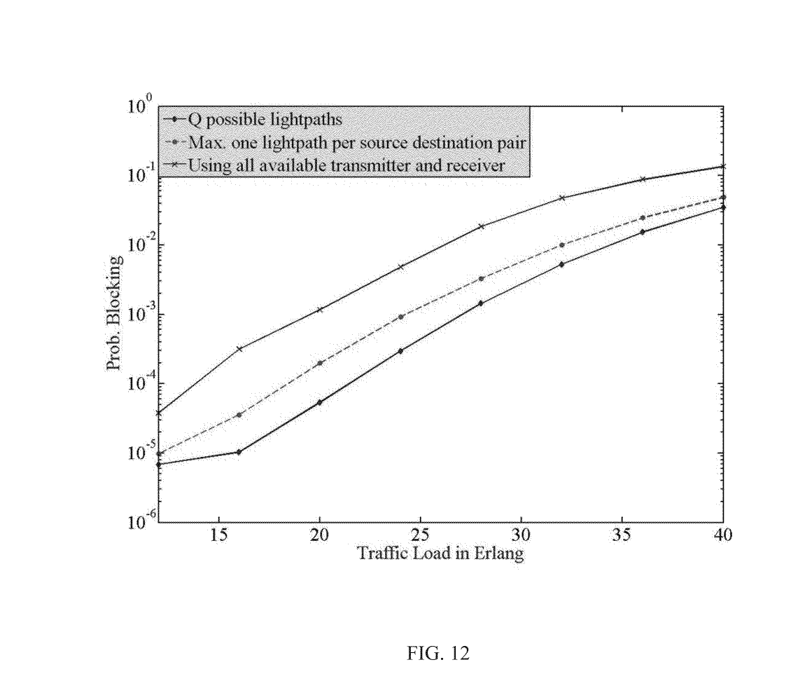

If the <= sign in formulas (2) and (3) is respectively replaced with the = sign, as shown in (14) and (15), it takes less time to solve the MILP problem compared. The performance with Q possible lightpaths between node pairs, restricting maximum of one lightpath per node pairs (Q=1) and using all the available transmitter and receiver in each nodes are shown in FIG. 12. FIG. 12 shows blocking performances with Q possible lightpaths between node pairs, restricting maximum of one lightpath per node pairs (Q=1) and using all the available transmitter and receiver in each nodes according to FIG. 3A for a sample non-uniform traffic matrix according to certain embodiments of the present disclosure. As shown in FIG. 12, the general trend is to use all available transmitters and receivers and establish at least one lightpath per node pairs. The performance showed that, for the traffic matrix shown in Table II, if using all the available transmitters and receivers, then blocking probability increases. Similarly, blocking might increase if maximum of one lightpath per node pairs is restricted as shown in FIG. 12.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### LISTING OF REFERENCES

[1]. D. J. Heatley, D. R. Wisely, I. Neild, and P. Cochrane, “Optical wireless: The story so far,” IEEE Commun. Mag., vol. 36, no. 12, pp. 72-82, December 1998.
[2]. S. Arnon, “Optimization of urban optical wireless communication systems”, IEEE Transactions on Wireless Communications, vol. 2, no. 4, pp. 626-629, 2003.
[3]. X. Liu, “Free-space optics optimization models for building sway and atmospheric interference using variable wavelength”, IEEE Transactions on Communications, vol. 57, no. 2, pp. 492-498, 2009.
[4]. R. Ramaswami, “Multiwavelength lightwave networks for computer communication,” IEEE Communications Magazine, February 1993.
[5]. B. Mukherjee, “WDM-based local lightwave networks, Part II: Multihop systems,” IEEE Network Magazine, July 1992.
[6]. Anthony. S. Acampora, “A multichannel multihop local lightwave network,” In Proceedings of Globecom'87, Tokyo, Japan, November 1987.
[7]. X. Liu, “Outage behavior of a MISO wireless optical link with pointing and tracking errors”, Proc. of IEEE ICC 2011.
[8]. M. Eisenberg and N. Mehravari, “Performance of the multichannel multihop lightwave network under nonuniform traffic,” IEEE Journal on Selected Areas in Communications, Volume 6, August 1988.
[9]. J. P. Labourdette and A. S. Acampora, Logically Rearrangable Multihop Lightwave Networks, IEEE Transaction on Communications, Volume 39 No. 8, August 1991.
[10]. J. P. Labourdette and A. S. Acampora, “Logically rearrangeable multihop lightwave networks,” IEEE Trans. Commun., Volume 39, pp. 1223-1230, August 1991.
[11]. J. P. Labourdette, F. W. Hart, and A. S. Acampora, “Branch-exchange sequences for reconfiguration of lightwave networks,” IEEE Transactions on Communications, Volume 42, pp. 2822-2832, October 1994.
[12]. G. N. Rouskas and M. H. Ammar, “Dynamic reconfiguration in multihop WDM networks,” Journal on High Speed Networks, Volume 4, no. 3, pp. 221-238, 1995.
[13]. I. Baldine and G. N. Rouskas, Traffic Adaptive WDM Networks: A Study of Reconfiguration Issues, Journal of Lightwave Technology, Volume 19, No. 4, April 2001.
[14]. J. P. Labourdette, “Performance Impact of Partial Reconfiguration on Multihop Lightwave Networks”, IEEE/ACM Transaction on Networking, Volume 5 No. 3, June 1997.
[15]. B. Mukherjee, D. Banerjee, S. Ramamurthy, and A. Mukherjee, “Some principles for designing a wide area optical network,” IEEE/ACM Trans. Networking, vol. 4, pp. 684-696, October 1996.
[16]. D. Banerjee and B. Mukherjee, “Wavelength-routed optical network: Linear formulation, resource budgeting tradeoffs, and a reconfiguration study,” in Proc. Infocom 1997, pp. 269-276.
[17]. R. M. Krishnaswamy and K. N. Sivarajan, “Design of logical topologies: a linear formulation for wavelength routed optical networks with no wavelength changers,” IEEE/ACM Transactions on Networking, vol. 9, No. 2, pp. 186-198, April 2001.
[18]. L. Berger, “Generalized Multi-Protocol Label Switching (GMPLS) signaling functional description,” RFC 3471, January 2003.
[19]. K. Lu, et. al., “Analysis of blocking probability for distributed lightpath establishment in WDM optical networks”, IEEE/ACM Transactions on Networking, Volume 13, No 1, February 2005, pp. 187-197.
[20]. L. Berger, “Generalized Multi-Protocol Label Switching (GMPLS) signaling resource reservation protocol-traffic engineering (RSVP-TE) extensions,” RFC 3473, IETF, January 2003.
[21]. R. Ghimire, and S. Mohan, “Auto Tracking System for Free Space Optical Communications,” ICTON 2011-13th International Conference on Transparent Optical Networks, Stockholm, Sweden, June 2011.
[22]. D. Kedar and S. Arnon, “Urban optical wireless communication networks: the main challenges and possible solutions,” IEEE Commun. Mag., vol. 42, no. 5, pp. S2-S7, 2004.
[23]. B. R. Strickland, M. J. Lavan, E. Woodbridge, and V. Chan, “Effects of fog on the bit-error rate of a free-space laser communication system,” Appl. Opt., vol. 38, no. 3, pp. 424-431, 1999.

What is claimed is:

1. A method for automatic tracking and dynamic routing for free space optical (FSO) communication, comprising the steps of:
(a) constructing a logical topology of a FSO network comprising a plurality of transmitters and a plurality of receivers, each of the transmitters and each of the receivers being assigned with a wavelength to form a plurality of physical links between the transmitters and the receivers, wherein each of the physical links is formed between one of the transmitters and one of the receivers being assigned with the same wavelength, wherein the logical topology comprises:
(i) a plurality of nodes, each representing at least one of the transmitters and at least one of the receivers; and
(ii) a plurality of logical links interconnecting the plurality of nodes, wherein each of the logical links represents a lightpath having a traffic thereon and comprises one or more of the physical links;
(b) optimizing the logical topology by calculating the traffic of each the lightpaths in the logical topology with a mesh architecture using a traffic matrix to minimize a maximum traffic flow of the lightpaths;
(c) calculating routing of the optimized logical topology to obtain a plurality of transmitter/receiver assignments for the transmitters and the receivers; and
(d) controlling routings of the transmitters and the receivers based on the corresponding transmitter/receiver assignments.

2. The method of claim 1, wherein the FSO network comprises M of the transmitters and M of the receivers in an M×M configuration, wherein M is a positive integer.

3. The method of claim 1, wherein each of the nodes is configured to communicate with at least one of the other of the nodes via at least one of the lightpaths.

4. The method of claim 1, wherein for each of the logical links, the nodes being interconnected by the logical link comprises a source node and a destination node.

5. The method of claim 4, wherein for each of the nodes,
a number of the lightpaths originating from the node is no greater than a number of transmitters being represented by the node, and
a number of the lightpaths terminating at the node is no greater than a number of receivers being represented by the node.

6. The method of claim 4, wherein for each of the logical links, the nodes being interconnected by the logical link further comprise one or more intermediate nodes.

7. The method of claim 4, wherein the optimizing the logical topology is performed using a mixed integer linear programming (MILP) formulation.

8. The method of claim 7, wherein the optimizing the logical topology is performed using the MILP formulation by:
applying degree constraints to the logical topology to constrain the logical topology to a predetermined logical degree;
applying wavelength continuity constraints to each of the lightpaths of the logical topology, such that for each of the lightpaths, only the transmitters and the receivers being assigned with a same wavelength are used at each the nodes being interconnected by the logical link representing the lightpath;
applying wavelength continuity constraints to the logical topology, such that for each of the nodes, each of the transmitters or each of the receivers being assigned with the wavelength is used by only one of the lightpaths;
applying conservation of wavelength constraints to the logical topology, such that for each of the lightpaths, at least one of the transmitters and at least one of the receivers being assigned with the same wavelength are reserved for the lightpath at each the nodes being interconnected by the logical link representing the lightpath;
applying traffic routing constraints to each of the lightpaths of the logical topology, such that for each of the lightpaths, the traffic on the lightpath is no more than the maximum traffic flow of the logical topology;
applying flow conservation constraints to each of the nodes of the logical topology, such that for each of the nodes, the traffic flowing into the node balances the traffic flowing out of the node; and
applying hop-bound constraints to the logical topology such that for each of the lightpaths, a summation of a number of hops along the lightpath is no greater than a hop bound of the lightpath.

9. The method of claim 1, wherein the calculating routing of the optimized logical topology is performed by generalized multi-protocol label switching (GMPLS) using a routing protocol and a signaling protocol.

10. The method of claim 9, wherein the routing protocol is open shortest path first with traffic engineering (OSPF-TE), and the signaling protocol is resource reservation protocol with traffic engineering (RSVP-TE).

11. The method of claim 1, further comprising:
in response to detecting a failure at a node or a physical link of the FSO network, re-performing steps (b)-(d) to re-optimize the logical topology of the FSO network with the failure.

12. A transceiver system for automatic tracking and dynamic routing for free space optical (FSO) communication, comprising:
(a) at least one FSO network, each comprising a plurality of transmitters and a plurality of receivers, each of the transmitters and each of the receivers being assigned with a wavelength to form a plurality of physical links between the transmitters and the receivers, wherein each of the physical links is formed between one of the transmitters and one of the receivers being assigned with the same wavelength; and
(b) a computer having a processor and a storage device storing computer executable codes, wherein the computer executable code, when executed at the processor, is configured to perform a method comprising:
(i) constructing a logical topology of each of the at least one FSO network, wherein the logical topology comprises:
(1) a plurality of nodes, each representing at least one of the transmitters and at least one of the receivers; and
(2) a plurality of logical links interconnecting the plurality of nodes, wherein each of the logical links represents a lightpath having a traffic thereon and comprises one or more of the physical links;
(ii) optimizing the logical topology by calculating the traffic of each the lightpaths in the logical topology with a mesh architecture using a traffic matrix to minimize a maximum traffic flow of the lightpaths;
(iii) calculating routing of the optimized logical topology to obtain a plurality of transmitter/receiver assignments for the transmitters and the receivers; and
(iv) controlling routings of the transmitters and the receivers based on the corresponding transceiver assignments.

13. The system of claim 12, wherein the FSO network comprises M of the transmitters and M of the receivers in an M×M configuration, wherein M is a positive integer.

14. The system of claim 12, wherein each of the nodes is configured to communicate with at least one of the other of the nodes via at least one of the lightpaths.

15. The system of claim 12, wherein for each of the logical links, the nodes being interconnected by the logical link comprises a source node and a destination node.

16. The system of claim 15, wherein for each of the nodes,
a number of the lightpaths originating from the node is no greater than a number of transmitters being represented by the node, and
a number of the lightpaths terminating at the node is no greater than a number of receivers being represented by the node.

17. The system of claim 15, wherein for each of the logical links, the nodes being interconnected by the logical link further comprise one or more intermediate nodes.

18. The system of claim 15, wherein the computer executable code, when executed at the processor, is configured to perform optimizing the logical topology using a mixed integer linear programming (MILP) formulation.

19. The system of claim 18, wherein the computer executable code, when executed at the processor, is configured to perform optimizing the logical topology using the MILP formulation by:
applying degree constraints to the logical topology to constrain the logical topology to a predetermined logical degree;
applying wavelength continuity constraints to each of the lightpaths of the logical topology, such that for each of the lightpaths, only the transmitters and the receivers being assigned with a same wavelength are used at each the nodes being interconnected by the logical link representing the lightpath;
applying wavelength continuity constraints to the logical topology, such that for each of the nodes, each of the transmitters or each of the receivers being assigned with the wavelength is used by only one of the lightpaths;
applying conservation of wavelength constraints to the logical topology, such that for each of the lightpaths, at least one of the transmitters and at least one of the receivers being assigned with the same wavelength are reserved for the lightpath at each the nodes being interconnected by the logical link representing the lightpath;
applying traffic routing constraints to each of the lightpaths of the logical topology, such that for each of the lightpaths, the traffic on the lightpath is no more than the maximum traffic flow of the logical topology;
applying flow conservation constraints to each of the nodes of the logical topology, such that for each of the nodes, the traffic flowing into the node balances the traffic flowing out of the node; and
applying hop-bound constraints to the logical topology such that for each of the lightpaths, a summation of a number of hops along the lightpath is no greater than a hop bound of the lightpath.

20. The system of claim 12, wherein the computer executable code, when executed at the processor, is configured to perform calculating routing of the optimized logical topology by generalized multi-protocol label switching (GMPLS) using a routing protocol and a signaling protocol.

21. The system of claim 20, wherein the routing protocol is open shortest path first with traffic engineering (OSPF-TE), and the signaling protocol is resource reservation protocol with traffic engineering (RSVP-TE).

22. The system of claim 12, wherein the computer executable code, when executed at the processor, is further configured to perform:
in response to detecting a failure at a node or a physical link of the FSO network, re-performing steps (b)-(d) to re-optimize the logical topology of the FSO network with the failure.

23. A non-transitory computer readable medium storing computer executable code, wherein the computer executable code, when executed at a processor, is configured to implement:
(a) constructing a logical topology of a free space optical (FSO) network comprising a plurality of transmitters and a plurality of receivers, each of the transmitters and each of the receivers being assigned with a wavelength to form a plurality of physical links between the transmitters and the receivers, wherein each of the physical links is formed between one of the transmitters and one of the receivers being assigned with the same wavelength, wherein the logical topology comprises:
(i) a plurality of nodes, each representing at least one of the transmitters and at least one of the receivers; and
(ii) a plurality of logical links interconnecting the plurality of nodes, wherein each of the logical links represents a lightpath having a traffic thereon and comprises one or more of the physical links;
(b) optimizing the logical topology by calculating the traffic of each the lightpaths in the logical topology with a mesh architecture using a traffic matrix to minimize a maximum traffic flow of the lightpaths;
(c) calculating routing of the optimized logical topology to obtain a plurality of transmitter/receiver assignments for the transmitters and the receivers; and
(d) controlling routings of the transmitters and the receivers based on the corresponding transmitter/receiver assignments.

24. The non-transitory computer readable medium of claim 23, wherein each of the nodes is configured to communicate with at least one of the other of the nodes via at least one of the lightpaths.

25. The non-transitory computer readable medium of claim 23, wherein for each of the logical links, the nodes being interconnected by the logical link comprises a source node and a destination node.

26. The non-transitory computer readable medium of claim 25, wherein for each of the nodes,
a number of the lightpaths originating from the node is no greater than a number of transmitters being represented by the node, and
a number of the lightpaths terminating at the node is no greater than a number of receivers being represented by the node.

27. The non-transitory computer readable medium of claim 25, wherein for each of the logical links, the nodes being interconnected by the logical link further comprise one or more intermediate nodes.

28. The non-transitory computer readable medium of claim 25, wherein the optimizing the logical topology is performed using a mixed integer linear programming (MILP) formulation.

29. The non-transitory computer readable medium of claim 28, wherein the computer executable code, when executed at the processor, is configured to perform optimizing the logical topology using the MILP formulation by:
applying degree constraints to the logical topology to constrain the logical topology to a predetermined logical degree;
applying wavelength continuity constraints to each of the lightpaths of the logical topology, such that for each of the lightpaths, only the transmitters and the receivers being assigned with a same wavelength are used at each the nodes being interconnected by the logical link representing the lightpath;
applying wavelength continuity constraints to the logical topology, such that for each of the nodes, each of the transmitters or each of the receivers being assigned with the wavelength is used by only one of the lightpaths;
applying conservation of wavelength constraints to the logical topology, such that for each of the lightpaths, at least one of the transmitters and at least one of the receivers being assigned with the same wavelength are reserved for the lightpath at each the nodes being interconnected by the logical link representing the lightpath;
applying traffic routing constraints to each of the lightpaths of the logical topology, such that for each of the lightpaths, the traffic on the lightpath is no more than the maximum traffic flow of the logical topology;
applying flow conservation constraints to each of the nodes of the logical topology, such that for each of the nodes, the traffic flowing into the node balances the traffic flowing out of the node; and
applying hop-bound constraints to the logical topology such that for each of the lightpaths, a summation of a number of hops along the lightpath is no greater than a hop bound of the lightpath.
